(19) United States
(12) Patent Application Publication
(10) Pub. No.: US 2025/0237367 A1
(43) Pub. Date: Jul. 24, 2025

(54) REFLECTING MIRROR, PROJECTION ASSEMBLY, VEHICLE LAMP AND VEHICLE

(71) Applicant: BEIJING CHEHEJIA AUTOMOBILE TECHNOLOGY CO., LTD., Beijing (CN)

(72) Inventors: Bolin SUN, Beijing (CN); Binbin TANG, Beijing (CN); Shiying ZHANG, Beijing (CN)

(21) Appl. No.: 18/859,824

(22) PCT Filed: Apr. 26, 2023
(86) PCT No.: PCT/CN2023/090949

§ 371 Date: Oct. 24, 2024

(30) Foreign Application Priority Data
Apr. 29, 2022 (CN) 202221046364.X

(51) Int. Cl. F21S 41/32; F21S 41/148; F21S 41/151; F21S 41/25

(52) U.S. Cl. CPC F21S 41/32; F21S 41/148; F21S 41/151; F21S 41/25

(57) ABSTRACT

A reflecting mirror, a projection assembly, a vehicle lamp and a vehicle. The reflecting mirror includes a light-reflecting surface. an intersection line of the light reflecting surface intersecting with a horizontal plane is a first intersection line, and the first intersection line satisfies: the following equation, where

$$( 0 , \frac{a}{4} )$$

is a focal of the light-reflecting surface, a is a constant greater than zero, l is a constant greater than zero, θ is an angle value greater than 0° and less than 90°, x is an independent variable, xϵ(−l, l), and f(x) is a dependent variable changing with x.

$$\{ \begin{matrix}\frac{tan \frac{- θ x}{l} \cdot {( \frac{d f ( x )}{d x} )}^{2} + 2 \cdot \frac{d f ( x )}{d x} + tan \frac{- θ x}{l}}{{( \frac{d f ( x )}{d x} )}^{2} - 2 tan \frac{- θ x}{l} \cdot \frac{d f ( x )}{d x} + 1} = \frac{x}{f ( x ) - \frac{a}{4}} ; \\ f ( 0 ) = 0\end{matrix}$$

### CROSS-REFERENCE TO RELATED APPLICATIONS

This application is a national stage entry under 35 U.S.C. § 371 of International Application No. PCT/CN2023/090949, filed on Apr. 26, 2023, which claims priority to Chinese Patent Application Serial No. 202221046364.X, filed on Apr. 29, 2022, the entire disclosures of which are hereby incorporated herein by reference.

### FIELD

The present disclosure relates to the field of automobile accessory technologies, and in particular to a reflecting mirror, a projection assembly, a vehicle lamp and a vehicle.

### BACKGROUND

A low-beam lamp of automobiles includes a light source, a reflecting mirror and a lens. A plurality of light sources are provided, the reflecting mirror has a plurality of light-reflecting surfaces, and the lens has a plurality of light-entering surfaces. The light source, the light-reflecting surface and the corresponding light-entering surface form an optical unit. The plurality of light sources, the plurality of light-reflecting surfaces and the plurality of light-entering surfaces form a plurality of optical units. In each optical unit, light emitted by the light source is reflected by the corresponding light-reflecting surface and converged near a focus of the corresponding light-entering surface. Light emitted by the plurality of light sources is finally refracted to a road surface through the lens to create illumination.

### SUMMARY

The present disclosure relates to the field of automobile accessory technologies, and in particular to a reflecting mirror, a projection assembly, a vehicle lamp and a vehicle.

According to a first aspect of the present disclosure, a reflecting mirror has a light-reflecting surface. An intersection line of the light-reflecting surface intersecting with a horizontal plane is a first intersection line, and the first intersection line satisfies:

$$\{ \begin{matrix}\frac{tan \frac{- θ x}{l} \cdot {( \frac{df ( x )}{dx} )}^{2} + 2 \cdot \frac{df ( x )}{dx} + tan \frac{- θ x}{l}}{{( \frac{df ( x )}{dx} )}^{2} - 2 tan \frac{- θ x}{l} \cdot \frac{df ( x )}{dx} + 1} = \frac{x}{f ( x ) - \frac{a}{4}} ; \\ f ( 0 ) = 0\end{matrix}$$

in which,

$$( 0 , \frac{a}{4} )$$

is a focus of the light-reflecting surface, the a is a constant greater than zero; the l is a constant greater than zero; the θ is an angle value greater than 0° and less than 90°; the x is an independent variable, xϵ(−l, l), and the f(x) is a dependent variable changing with the x.

According to a second aspect of the present disclosure, a projection assembly includes a plurality of optical units. Each optical unit includes a reflecting mirror and a lens, in which the reflecting mirror has a light-reflecting surface, the lens has a light-entering surface, and the light-entering surface is arranged to correspond to the light-reflecting surface. Each optical unit has an optical axis extending in a second direction, the light-reflecting surface and the corresponding light-entering surface are arranged along the second direction, and the reflecting mirror of part of the plurality of optical units is the reflecting mirror described in any of above embodiments.

According to a third aspect of the present disclosure, a vehicle lamp includes the projection assembly as described in any of above embodiments.

According to a fourth aspect of the disclosure, a vehicle includes the vehicle lamp as described in any of above embodiments.

### BRIEF DESCRIPTION OF THE DRAWINGS

FIG. 1 is a perspective view of a projection assembly of an embodiment of the present disclosure.

FIG. 2 is a front view of a projection assembly of an embodiment of the present disclosure.

FIG. 3 is a top view of a projection assembly of an embodiment of the present disclosure.

FIG. 4 is a light path diagram of a first main optical unit on a left side in FIG. 3.

FIG. 5 is a beam pattern effect diagram of the first main optical unit in FIG. 4.

FIG. 6 is a light path diagram of a first main optical unit on a right side in FIG. 3.

FIG. 7 is a beam pattern effect diagram of the first main optical unit in FIG. 6.

FIG. 8 is a light path comparison diagram between a first main optical unit in FIG. 3 and a main optical unit in the related art.

FIG. 9 is a beam pattern effect diagram of a second main optical unit in FIG. 3.

FIG. 10 is a beam pattern effect diagram produced by two first main optical units and a second main optical unit in FIG. 3.

FIG. 11 is a beam pattern effect diagram produced by all optical units in FIG. 3.

FIG. 12 is an exploded view of a vehicle lamp of an embodiment of the present disclosure.

FIG. 13 is a front view of a vehicle lamp of an embodiment of the present disclosure (a radiator is hidden).

FIG. 14 is an A-A view of FIG. 13.

FIG. 15 is an exploded view of a lens, a light-blocking member and a frame in FIG. 12.

FIG. 16 is a perspective view of a lens in FIG. 12.

FIG. 17 is a perspective view of a reflecting mirror in FIG. 12.

FIG. 18 is a front view of a reflecting mirror in FIG. 12.

FIG. 19 is a B-B view of FIG. 18.

### DETAILED DESCRIPTION

Embodiments of the present disclosure are described in detail below, and examples of embodiments are illustrated in accompanying drawings. Embodiments described below with reference to the accompanying drawings are illustrative and are intended to be used to explain the present disclosure, and cannot be understood as limitation of the present disclosure.

A vehicle lamp includes a low-beam lamp and a high-beam lamp. Light of the high-beam lamp is emitted in parallel, and the light is concentrated with a great brightness, which may illuminate a higher and farther object. Light emitted by the low-beam lamp is emitted in a divergent state, and may illuminate an object in a larger range nearby. As an eye of an automobile, the vehicle lamp is not only related to an external image of a vehicle owner, but also closely related to safe driving at night or in a bad weather condition. Therefore, a road illuminating effect of the vehicle lamp is crucial for the safe driving. In the related art, a plurality of main optical units of the low-beam lamp have the same structure, so that an angle of a beam pattern produced by each main optical unit in a left and right direction is the same, which results in a clear bright spot boundary of the beam pattern produced by the low-beam lamp, and a poor road illuminating effect.

Part of the plurality of optical units is a main optical unit, and the main optical unit may produce a main beam pattern with a light and dark cut-off line. Another part of the optical units is an auxiliary optical unit, the auxiliary optical unit produces an auxiliary beam pattern, and a width of the auxiliary beam pattern in a left and right direction is greater than a width of the main beam pattern. In order to have more energy near the light and dark cut-off line, to make the low-beam lamp shine further, a plurality of main optical units are usually provided. In the related art, the reflecting surfaces of the plurality of main optical units have the same structure, so that the beam patterns produced by the plurality of main optical units have the same average angle in the left and right direction. When using the low-beam lamp illumination, left and right boundaries of the beam patterns produced by the plurality of main optical units are completely coincided, which eventually results in a clear bright spot boundary of the beam pattern produced by the low-beam lamp, and a poor road illuminating effect.

In an optical design, most reflecting mirrors use a parabolic surface as a base surface. The so-called using the parabolic surface as the base surface is to adjust a profile angle on the basis of the parabolic surface to achieve an adjustment of a reflecting angle of light, in order to meet our needs for adjusting a light ray angle. A requirement for the low-beam lamp of the automobile is to have a larger angle in an H-H (horizontal) direction, but a smaller angle in a V-V (vertical) direction to achieve more energy near the light and dark cut-off line, so that the low-beam lamp may shine further.

When the angles of the beam patterns produced by different optical units in the left and right direction are different, the left and right boundaries of the beam patterns produced by different optical units may be misaligned, thereby avoiding the clear bright spot boundary caused by the completely coincided left and right boundaries of a plurality of beam patterns.

Based on at least one of the above problems, embodiments of the present disclosure provides a reflecting mirror, a projection assembly, a vehicle lamp and a vehicle, which may dilute the boundary of the beam pattern produced by the low-beam lamp, improve the road illuminating effect of the vehicle lamp, and thus improve a driving safety.

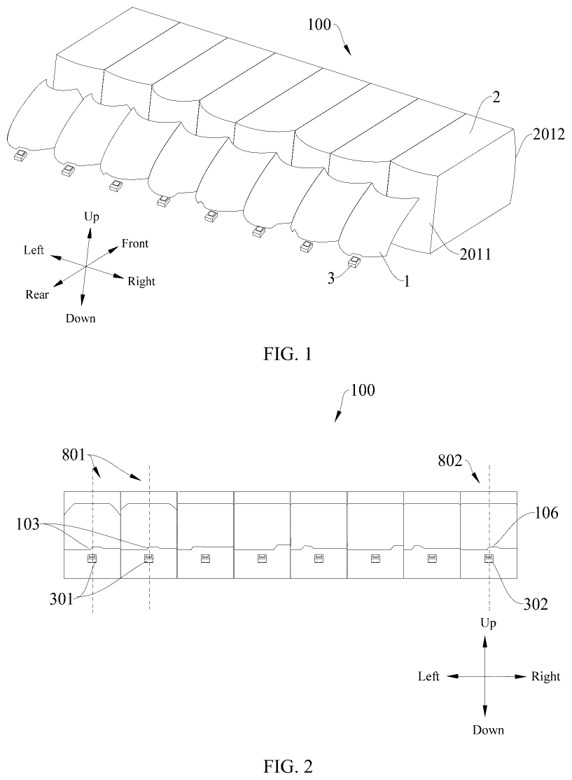

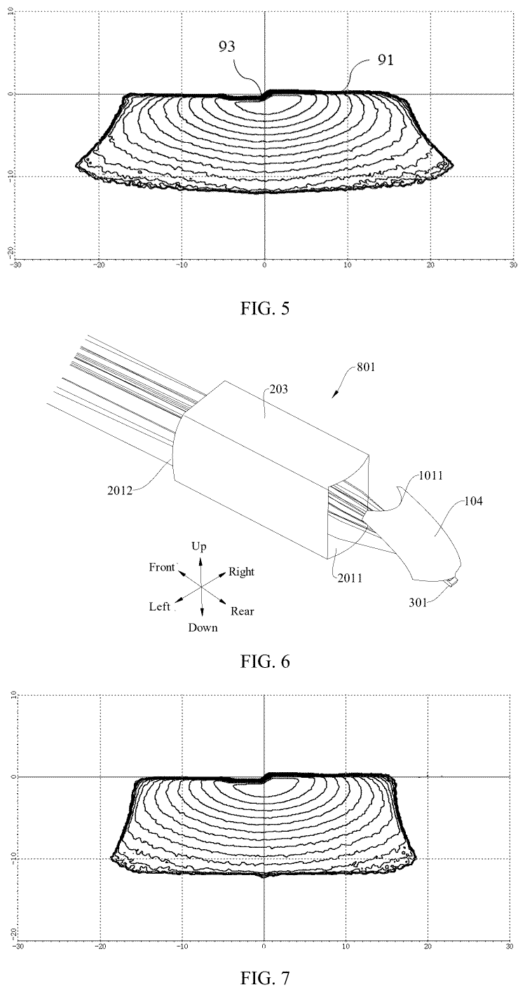

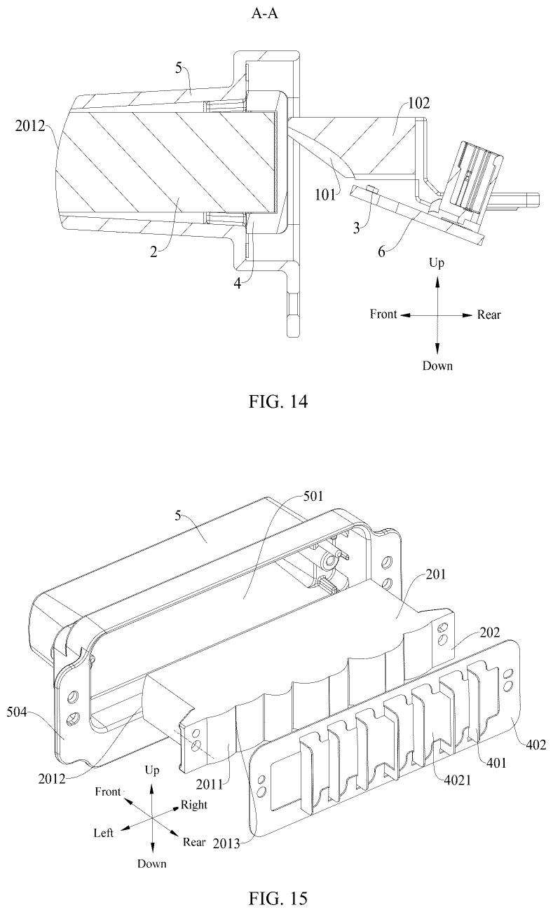

As illustrated in FIGS. 1 to 8 and FIGS. 12 to 14, a projection assembly 100 includes a plurality of optical units, each optical unit includes a reflecting mirror 1 and a lens 2. The reflecting mirror 1 has a light-reflecting surface 101, the lens 2 has a light-entering surface 2011, and the light-entering surface 2011 is arranged to correspond to the light-reflecting surface 101. Each optical unit has an optical axis extending along a second direction (a front and rear direction), and the light-reflecting surface 101 and the corresponding light-entering surface 2011 are arranged along the second direction (front and rear direction). The reflecting mirror 1 of part of the plurality of optical units employs the reflecting mirror 1 illustrated in FIGS. 4 and 6.

Each optical unit also includes a light source 3, and light emitted by the light source 3 is reflected by the light-reflecting surface 101 of the reflecting mirror 1 to the vicinity of a focus of the light-entering surface 2011 of the lens 2, and finally refracted to a road surface through the lens 2 to produce a beam pattern for illumination. The beam pattern refracted by the lens 2 onto the road surface is substantially that the lens 2 projects the illuminated light-reflecting surface 101 of the reflecting mirror 1 as an object onto a front of the vehicle through the lens 2, and form an image inverted in an up and down direction and the left and right direction.

As illustrated in FIGS. 4 to 6, the reflecting mirror 1 of embodiments of the present disclosure has the light-reflecting surface 101, the light-reflecting surface 101 has a first intersection line 1011, and the first intersection line 1011 satisfies:

$$\{ \begin{matrix}\frac{tan \frac{- θ x}{l} \cdot {( \frac{df ( x )}{dx} )}^{2} + 2 \cdot \frac{df ( x )}{dx} + tan \frac{- θ x}{l}}{{( \frac{df ( x )}{dx} )}^{2} - 2 tan \frac{- θ x}{l} \cdot \frac{df ( x )}{dx} + 1} = \frac{x}{f ( x ) - \frac{a}{4}} ; \\ f ( 0 ) = 0\end{matrix}$$

in which,

$$( 0 , \frac{a}{4} )$$

is a focus of the light-reflecting surface 101, the a is a constant greater than zero; the l is a constant greater than zero; the θ is an angle value greater than 0° and less than 90°; the x is an independent variable, xϵ(−l, l), and the f(x) is a dependent variable changing with the x.

It should be noted that a size of the a is related to a position of the focus of the light-reflecting surface 101. Specifically, the focus of the light-reflecting surface 101 is

$$( 0 , \frac{a}{4} ) .$$

A size of the l is related to a size of an opening of the light-reflecting surface 101. Specifically, the opening of the light-reflecting surface 101 is equal to 2l. The θ is an angle between outgoing light at an edge of the light-reflecting surface 101 and a baseline, in which, light shining on the light-reflecting surface 101 is incoming light, light reflected by the light-reflecting surface 101 is the outgoing light, and the baseline may be understood as a straight line with x=l. For the plurality of light-reflecting surfaces 101 with different θ, an angle of the outgoing light on each light-reflecting surface 101 is also different. For the plurality of light-reflecting surfaces 101 with different a, the position of the focus of each light-reflecting surface 101 is also different. For the plurality of light-reflecting surfaces 101 with different l, the size of the opening of each light-reflecting surface 101 is also different.

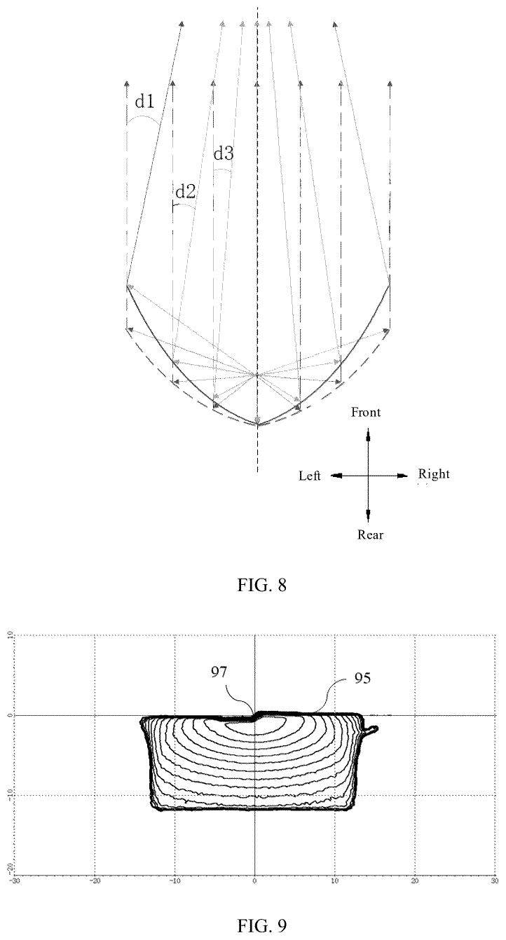

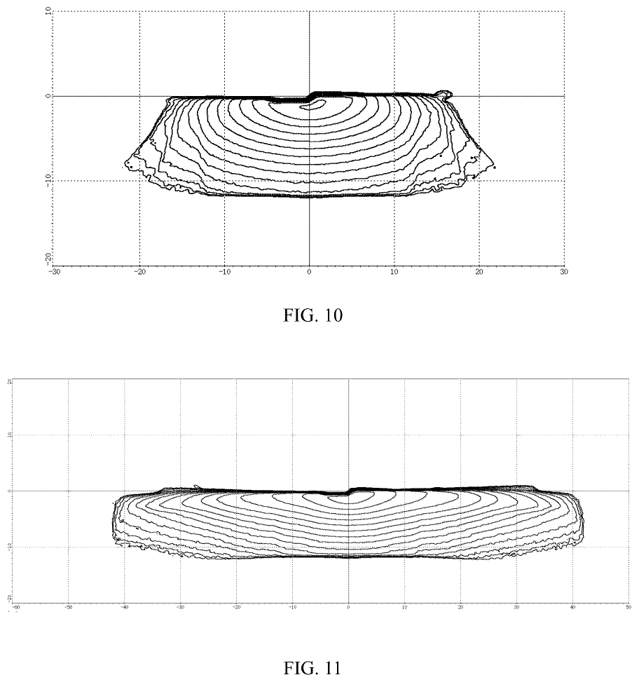

As illustrated in FIG. 8, for ease of understanding, the technical solutions of the present disclosure are described by taking the first intersection line 1011 of the light-reflecting surface 101 extending along the left and right direction, and the light-reflecting surface 101 being arranged facing forward as an example.

The light-reflecting surface 101 of the reflecting mirror 1 in embodiments of the present disclosure, compared to the light-reflecting surface of the reflecting mirror being a parabolic surface in the related art (a polygonal line in FIG. 8), shrinks on both sides in a direction close to a front and rear center line (a center line extended along the front and rear direction). The light reflected from the light-reflecting surface 101 tilts towards a direction close to the front and rear center line, so that the light reflected by the light-reflecting surface 101 is a divergent light. Therefore, when the light reflected from the reflecting mirror 1 passes through the lens 2, the beam pattern projected will diverge along the left and right direction, which, compared with the related art, may increase an angle of the beam pattern produced by the optical unit using the reflecting mirror in the left and right direction. By adjusting a profile of the light-reflecting surface 101 of the reflecting mirror 1, for example, by adjusting the value of 0, an angle of the light reflected by the light-reflecting surface 101 may be changed, and the angle of the beam pattern produced by the optical unit using the reflecting mirror in the left and right direction is adjusted, so that left and right boundaries of the beam patterns produced by the plurality of the optical units do not completely coincide, thus the bright spot boundary generated by the low-beam lamp may be reduced or even avoided, improving the road illuminating effect.

In addition, by above arrangement of the light-reflecting surface 101, an inclination angle of the outgoing light emitted through the light-reflecting surface 101 is positively correlated with the position of the incoming light shining on the light-reflecting surface 101. Specifically, the farther the position of the light shining on the light-reflecting surface 101 is to the front and rear center line of the light-reflecting surface 101 (extending along the front and rear direction), the greater the inclination angle of the reflected light, that is, d1>d2>d3 in FIG. 8, so that an iso-illuminance line and the beam pattern projected by the light reflected from the reflecting mirror 1 through the lens 2 are controllable, facilitating a design of the beam pattern and improving an road illuminating uniformity.

Therefore, the reflecting mirror 1 according to embodiments of the present disclosure may reduce or even avoid the bright spot boundary generated by the low-beam, improving the road illuminating effect.

In some embodiments, the θϵ(5°, 10°).

By setting the θ to 5°˜10°, the requirements of most optical units may be met, and the reflecting mirror 1 may have a smaller dimension, which is conducive to a miniaturization and lightweight design of the reflecting mirror 1.

In some embodiments, the l≤10 mm.

By setting the l to 0˜10 mm, the requirements of most optical units may be met, and the reflecting mirror 1 may have a smaller dimension, which is conducive to the miniaturization and lightweight design of the reflecting mirror 1.

In some embodiments, an intersection line of the light-reflecting surface 101 intersecting with a vertical plane is a second intersection line 1013, and the second intersection line 1013 satisfies:

$$\{ \begin{matrix}\frac{tan \frac{- γ p}{M} \cdot {( \frac{df ( p )}{dp} )}^{2} + 2 \cdot \frac{df ( p )}{dp} + tan \frac{- γ p}{m}}{{( \frac{df ( p )}{dp} )}^{2} - 2 tan \frac{- γ p}{m} \cdot \frac{df ( p )}{dp} + 1} = \frac{p}{f ( p ) - \frac{b}{4}} ; \\ f ( 0 ) = 0\end{matrix}$$

in which,

$$( 0 , \frac{b}{4} )$$

is a focus of the light-reflecting surface 101, the b is a constant greater than zero; the m is a constant greater than zero; the γ is an angle value greater than 0° and less than 90°; the p is an independent variable, pϵ(−m, m), and the f(p) is a dependent variable changing with the p.

It should be noted that a size of the b is related to the position of the focus of the light-reflecting surface 101. Specifically, the focus of the light-reflecting surface 101 is

$$( 0 , \frac{b}{4} ) .$$

A size of the m is related to the size of the opening of the light-reflecting surface 101. Specifically, the opening of the light-reflecting surface 101 is equal to 2 m. The γ is an angle between the outgoing light at the edge of the light-reflecting surface 101 and the baseline, in which, the light shining on the light-reflecting surface 101 is the incoming light, the light reflected by the light-reflecting surface 101 is the outgoing light, and the baseline may be understood as a straight line with p=m. For the plurality of light-reflecting surfaces 101 with different γ, the angle of the outgoing light on each light-reflecting surface 101 is also different. For the plurality of light-reflecting surfaces 101 with different b, the position of the focus of each light-reflecting surface 101 is also different. For the plurality of light-reflecting surfaces 101 with different m, the size of the opening of each light-reflecting surface 101 is also different. In addition, the light-reflecting surface 101 has only one focus,

$$( 0 , \frac{a}{4} ) and ( 0 , \frac{b}{4} )$$

are only the position representations of the focus on different intersection lines.

For ease of understanding, the technical solutions of the present disclosure is described by taking the second intersection line 1013 of the light-reflecting surface 101 extending in the up and down direction as an example.

The light-reflecting surface 101 of the reflecting mirror 1 in embodiments of the present disclosure, compared to the light-reflecting surface of the reflecting mirror being the parabolic surface in the related art, shrinks on both sides in the direction close to an up and down center line (a center line extended along the up and down direction). The light reflected from the light-reflecting surface 101 tilts towards a direction close to the up and down center line, so that the light reflected by the light-reflecting surface 101 is the divergent light. Therefore, when the light reflected from the reflecting mirror passes through the lens, the beam pattern projected will diverge along the up and down direction, which, compared with the related art, may increase an angle of the beam pattern produced by the optical unit using the reflecting mirror in the up and down direction. By adjusting the profile of the light-reflecting surface 101 of the reflecting mirror 1, for example, by adjusting the value of γ, the angle of the light reflected by the light-reflecting surface 101 may be changed, and the angle of the beam pattern produced by the optical unit using the reflecting mirror in the up and down direction is adjusted.

In some embodiments, the γϵ(5°, 10°).

By setting the γ to 5°˜10°, the requirements of most optical units may be met, and the reflecting mirror 1 may have a smaller dimension, which is conducive to the miniaturization and lightweight design of the reflecting mirror 1.

In some embodiments, the m≤10 mm.

By setting the m to 0˜10 mm, the requirements of most optical units may be met, and the reflecting mirror 1 may have a smaller dimension, which is conducive to the miniaturization and lightweight design of the reflecting mirror 1.

In other embodiments, the second intersection line 1013 may also be a parabola.

In some embodiments, a dimension of the light-reflecting surface 101 in the left and right direction is 5 mm to 15 mm.

For example, the dimension of the light-reflecting surface 101 in the left and right direction is 10 mm.

In some embodiments, a focal length of the light-reflecting surface 101 is 0.5 mm˜3 mm. For example, the focal length of the light-reflecting surface 101 is 1 mm, which allows a smaller focal length of the light-reflecting surface 101, which is beneficial to improve brightness and light efficiency of the projection assembly 100 shining on the road surface.

In some embodiments, the lens 2 has a light-exiting surface 2012 corresponding to the light-entering surface 2011, the light-entering surface 2011 is a light-entering surface 2011 collimated in a first direction, and the light-exiting surface 2012 is a light-exiting surface 2012 collimated in a third direction.

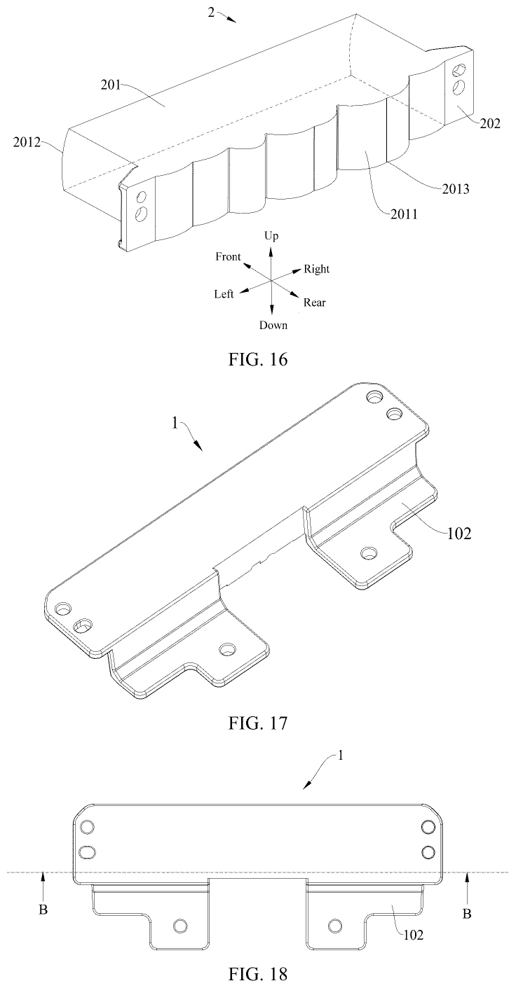

As illustrated in FIGS. 1, 15, and 16, the lens 2 has a light-exiting surface 2012 corresponding to the light-entering surface 2011, the light-entering surface 2011 is a light-entering surface 2011 collimated in the left and right direction, and the light-exiting surface 2012 is a light-exiting surface 2012 collimated in the up and down direction.

It may be understood that the up and down direction is consistent with a coordinate system of the vehicle using the projection assembly 100. In other words, the up and down direction is an up and down direction of the coordinate system of the vehicle. The up and down direction is the up and down direction of the vehicle.

The light-entering surface 2011 is the light-entering surface 2011 collimated in the left and right direction, which may be understood as follows: an intersection line of the light-entering surface 2011 in the left and right direction is a convex curve, and the light-entering surface 2011 has a large degree of deflection to the light in the left and right direction, which may have a certain collimating effect on the divergent light; and an intersection line of the light-entering surface 2011 in the up and down direction is a straight line, and the light-entering surface 2011 has a weak deflection ability to the light in the up and down direction and does not have the collimating effect.

The light-exiting surface 2012 is the light-exiting surface 2012 collimated in the up and down direction, which may be understood as follows: an intersection line of the light-exiting surface 2012 in the up and down direction is a convex curve, and the light-exiting surface 2012 has a large degree of deflection to the light in the up and down direction, which may have a certain collimating effect on the divergent light; and an intersection line of the light-exiting surface 2012 in the left and right direction is a straight line, and the light-exiting surface 2012 has a weak deflection ability to the light in the left and right direction and does not have the collimating effect.

By setting the light-entering surface 2011 of the lens 2 as the light-entering surface 2011 with the collimation in the first direction and the light-exiting surface 2012 of the lens 2 as the light-exiting surface 2012 with the collimation in the third direction, it is convenient for the projection assembly of the low-beam lamp to produce an asymmetric beam pattern on the road surface, for example, to produce a rectangular beam pattern with a large dimension in the left and right direction and a small dimension in the up and down direction.

In some embodiments, the light-entering surface 2011 and the light-exiting surface 2012 are spaced apart in the second direction.

For example, the light-entering surface 2011 and the light-exiting surface 2012 are spaced apart in the front and rear direction.

In some embodiments, part of the plurality of optical units is a first main optical unit 801, and the reflecting mirror 1 of the first main optical unit 801 is the reflecting mirror 1 illustrated in FIGS. 4 and 6. The first main optical unit 801 satisfies that: a side of the light-reflecting surface 101 distant from the light-entering surface 2011 is provided with a first low-beam cut-off line 103 capable of forming a first light and dark cut-off line 91, the first low-beam cut-off line 103 has a first inflection point 1034 capable of forming an elbow 93 of the first light and dark cut-off line 91, and the first inflection point 1034 is arranged on the optical axis.

By setting the first low-beam cut-off line 103 on the light-reflecting surface 101 of the first main optical unit 801, when the illuminated light-reflecting surface 101 of the reflecting mirror 1 is acted as an object and projected to the front of the vehicle through the lens 2, a formed image (the beam pattern) has a bright line consistent with the shape of the first low-beam cut-off line 103, and the bright line is the first light and dark cut-off line 91. The first low-beam cut-off line 103 is a polygonal line, and the first low-beam cut-off line 103 includes a plurality of line segments sequentially coupled. A coupling point between adjacent line segments is an inflection point. There are adjacent first inflection point 1034 and third inflection point 1035 on the first low-beam cut-off line 103. The first inflection point 1034 is located at a right side of the third inflection point 1035, and the first inflection point 1034 is higher than the third inflection point 1035. When the light-reflecting surface 101 of the illuminated reflecting mirror 1 is acted as the object and projected to the front of the vehicle through the lens 2, an image of the first inflection point 1034 and an image of the third inflection point 1035 are located on the first light and dark cut-off line 91, the image of the first inflection point 1034 is located at a left side of the image of the third inflection point 1035, and the image of the first inflection point 1034 is lower than the image of the third inflection point 1035. From an appearance, the image of the first inflection point 1034 is similar to an “elbow” of human, and the image of the third inflection point 1035 is similar to a “shoulder” of human.

For example, as illustrated in FIGS. 2 to 7, it may be understood that the first low-beam cut-off line 103 may produce the first light and dark cut-off line 91 of the low-beam lamp, and the first inflection point 1034 may produce the “elbow” 93 of the first light and dark cut-off line 91. The first low-beam cut-off line 103 includes a first segment 1031, a second segment 1032, and a third segment 1033 coupled sequentially from left to right. The first segment 1031 is arranged at a lower side of the third segment 1033, and a left end of the second segment 1032 is low and a right end of the second segment 1032 is high. An inflection point is formed between the first segment 1031 and the second segment 1032, and is capable of forming the “shoulder” of the first light and dark cut-off line 91. The first inflection point 1034 is formed between the third segment 1033 and the second segment 1032.

In some embodiments, an inclination angle of the second segment 1032 is 45°.

In some embodiments, at least one of the first segment 1031, the second segment 1032, and the third segment 1033 is the straight line.

For example, the first segment 1031, the second segment 1032 and the third segment 1033 are straight lines. At this time, the first segment 1031, the second segment 1032 and the third segment 1033 form the polygonal line.

It is understandable that when the first segment 1031 and the third segment 1033 are straight lines, the first segment 1031 and the third segment 1033 may be straight lines parallel to the left and right direction, or may be oblique lines intersecting the left and right direction.

In some embodiments, at least one of the first segment 1031, the second segment 1032, and the third segment 1033 is a curve.

For example, the first segment 1031 and the third segment 1033 are straight lines, and the second segment 1032 is the curve.

In some embodiments, a plurality of first main optical units 801 are provided, in which one of the θ of the first main optical units 801 is larger than the θ of at least one of the remaining first main optical units 801.

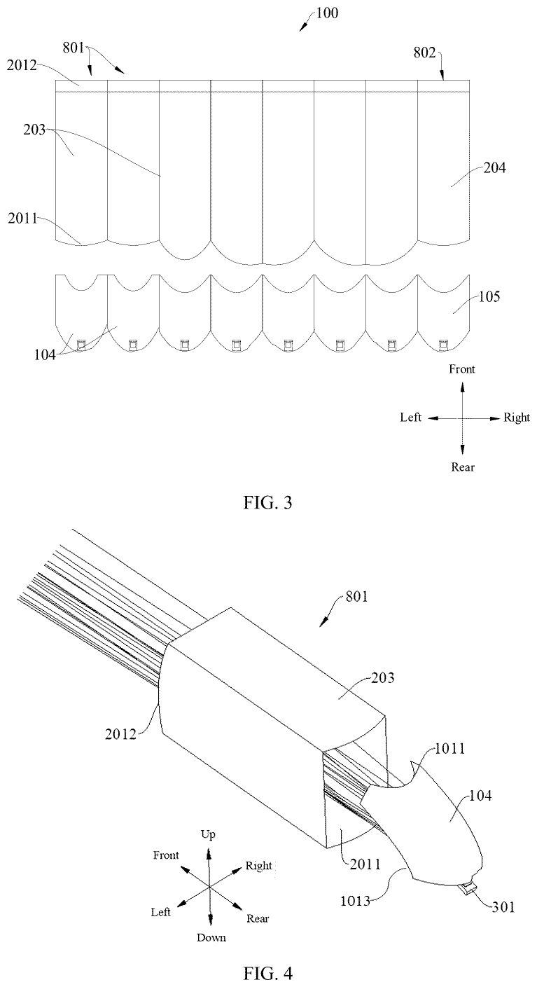

For example, as illustrated in FIGS. 2 and 3, the number of the first main optical units 801 is two, one of the first main optical units 801 is located on a left side of the other first main optical unit 801, and the θ of the first main optical unit 801 located on the left side is greater than the θ of the first main optical unit 801 located on its right side. In the first main optical unit 801, the lens 2 is a first lens 203, the reflecting mirror 1 is a first reflecting mirror 104, and the light source 3 is a first light source 301. The first lens 203, the first reflecting mirror 104, and the first light source 301 are arranged in the front and rear direction. Two first lenses 203 are arranged in the left and right direction, two first reflecting mirrors 104 are arranged in the left and right direction, and two first light sources 301 are arranged in the left and right direction.

By setting the θ of one of the first main optical unit 801 to be greater than the θ of the other first main optical unit 801, the angles of the beam patterns produced by the two first main optical units 801 in the left and right direction are different, which is conducive to an uniform transition of energy of the beam pattern produced by the projection assembly 100 from the center to the left and right sides, and more effectively avoids the clear bright spot boundary caused by the completely coincided left and right boundaries of the plurality of beam patterns.

In some embodiments, part of the plurality of optical units is a second main optical unit 802, the light-reflecting surface 101 of the reflecting mirror 1 of the second main optical unit 802 is the parabolic surface, and the second main optical unit 802 satisfies that: the side of the light-reflecting surface 101 distant from the light-entering surface 2011 is provided with a second low-beam cut-off line 106 capable of forming a second light and dark cut-off line 95, the second low-beam cut-off line 106 has a second inflection point 1061 capable of forming an elbow 97 of the second light and dark cut-off line 95, and the second inflection point 1061 is arranged on the optical axis.

Similar to the first low-beam cut-off line 103, the second low-beam cut-off line 106 is a polygonal line. The second low-beam cut-off line 106 may produce the second light and dark cut-off line 95 of the low-beam lamp, and the second inflection point 1061 may produce the “elbow” 97 of the second light and dark cut-off line 95.

The second low-beam cut-off line 106 and the first low-beam cut-off line 103 have a overlapping part, and the “elbow” 93 of the first light and dark cut-off line 91 coincides with the “elbow” 97 of the second light and dark cut-off line 95.

In the second main optical unit 802, the lens 2 is a second lens 204, the reflecting mirror 1 is a second reflecting mirror 105, and the light source 3 is a second light source 302. The second lens 204, the second reflecting mirror 105 and the second light source 302 are arranged in the front and rear direction.

A numerical solution method of the reflecting surface of the reflecting mirror in the embodiments of the present disclosure:

### (1) Principle of Numerical Solution

First order Taylor expansion for any point A(x, f(x)) on function y=f(x):

$${f ( x ) = f ( {x}_{0} ) + \frac{df ( x )}{dx} \vert}_{x = {x}_{0}} ( x - {x}_{0} ) + o [ {( x - {x}_{0} )}^{2} ] ,$$

for a first order numerical solution of the function, Peano remainder o[(x−x₀)²] may be ignored.

When x→x₀, then:

$${{lim}_{x \to {x}_{0}} f ( x ) = f ( {x}_{0} ) + \frac{df ( x )}{dx} \vert}_{x = {x}_{0}} ( x - {x}_{0} ) .$$

Computational domain xϵ[0, l] is evenly divided into N+1 points

$${A}_{i} ( {x}_{i} , f ( {x}_{i} ) ) , {x}_{i} = \frac{i}{N} l , i = 0 , 1 , 2 , … , N .$$

When N→∞, xᵢ₊₁→xᵢ:

$${{lim}_{{x}_{i + 1} \to {x}_{i}} f ( {x}_{i + 1} ) = f ( {x}_{i} ) + \frac{df ( x )}{dx} \vert}_{{x}_{i + 1}} ( {x}_{i + 1} - {x}_{i} ) ,$$

$$i . e . ,$$

$${{lim}_{{x}_{i + 1} \to {x}_{i}} \frac{df ( x )}{dx} \vert}_{{x}_{i + 1}} = \frac{f ( {x}_{i + 1} ) - f ( {x}_{i} )}{{x}_{i + 1} - {x}_{i}} .$$

### (2) Numerical Solution of Difference Equation

From the above, when N is large enough, and according to

$${x}_{i} = \frac{i}{N} l , i = 0 , 1 , 2 , … , N ,$$

the following equation may be established by default:

$${\frac{df ( x )}{dx} \vert}_{{x}_{i + 1}} = \frac{f ( {x}_{i + 1} ) - f ( {x}_{i} )}{{x}_{i + 1} - {x}_{i}} = \frac{i}{N} l [ f ( {x}_{i + 1} ) - f ( {x}_{i} ) ] .$$

For
i=0, 1, 2, . . . , N−1, according to

$$\{ \begin{matrix}\frac{tan \frac{θx}{l} \cdot {( \frac{df ( x )}{dx} )}^{2} + 2 \cdot \frac{df ( x )}{dx} + tan \frac{θx}{l}}{{( \frac{df ( x )}{dx} )}^{2} - 2 tan \frac{θx}{l} \cdot \frac{df ( x )}{dx} + 1} = \frac{x}{f ( x ) - \frac{a}{4}} , \\ f ( 0 ) = 0\end{matrix} .$$

the following difference equation system may be constructed:

$$\{ \begin{matrix}\frac{\begin{matrix}tan \frac{θ {x}_{i}}{l} \cdot {\{ \frac{i}{N} l [ f ( {x}_{i + 1} ) - f ( {x}_{i} ) ] \}}^{2} + \\ 2 \cdot \frac{i}{N} l [ f ( {x}_{i + 1} ) - f ( {x}_{i} ) ] + tan \frac{θ {x}_{i}}{l}\end{matrix}}{\begin{matrix}{\{ \frac{i}{N} l [ f ( {x}_{i + 1} ) - f ( {x}_{i} ) ] \}}^{2} - \\ 2 tan \frac{θ {x}_{i}}{l} \cdot \frac{i}{N} l [ f ( {x}_{i + 1} ) - f ( {x}_{i} ) ] + 1\end{matrix}} = \frac{{x}_{i}}{f ( {x}_{i} ) - \frac{a}{4}} , \\ f ( 0 ) = 0\end{matrix} .$$

in which, i=0, 1, 2, . . . , N−1. By iteratively solving the equation system and determining all nodes

$${A}_{i} ( {x}_{i} , f ( {x}_{i} ) ) , {x}_{i} = \frac{i}{N} l , i = 0 , 1 , 2 , … , N ,$$

an image of the function y=f(x) may be drawn, i.e., the image of the first intersection line.

In addition, an image of the second intersection line 1013 may be drawn by the above method, and the light-reflecting surface may be obtained by translating the first intersection line with the second intersection line 1013 as a trajectory line. When designing the reflecting mirror 1, a size of a, l and θ may be set according to the needs, so that the designed reflecting mirror 1 may meet use requirements.

In some embodiments, the light source 3 is a surface light source 3, and the number of the light sources 3 is 5˜10.

For example, as illustrated in FIGS. 1 to 3, the number of the light sources 3 is 8. In some embodiments, the light source 3 is an LED.

In some embodiments, the plurality of lenses 2 have a one-piece structure, and a separation part 2013 is formed between the light-entering surfaces 2011 of adjacent lenses 2.

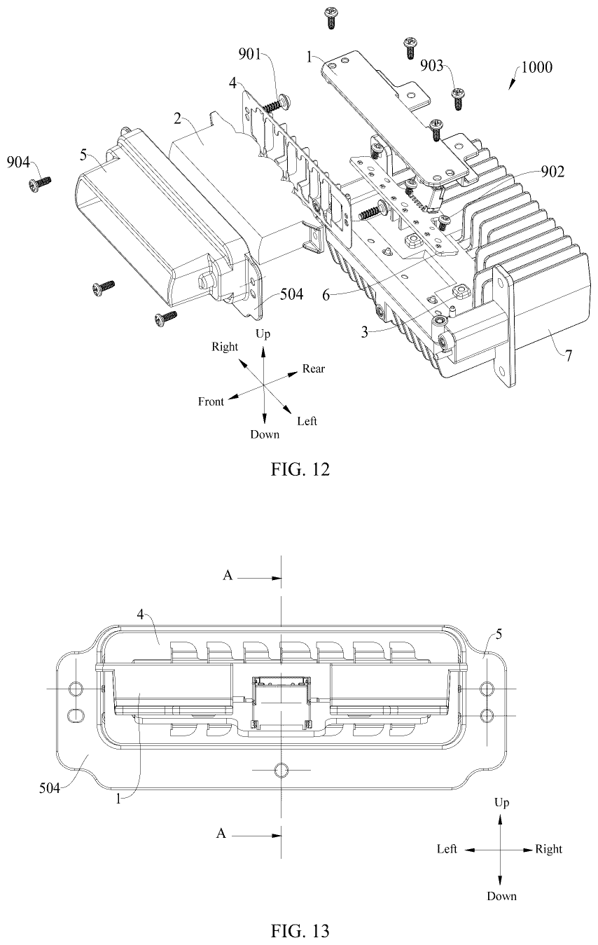

For example, as illustrated in FIGS. 12 to 15, eight lenses 2 have a one-piece structure, and the eight lenses 2 forms a lens group. The eight light-entering surfaces 2011 of the lens group are coupled sequentially to form a wave surface. The eight light-exiting surfaces 2012 of the lens group are coupled sequentially to form a convex surface.

In some embodiments, the plurality of reflecting mirrors 1 have a one-piece structure.

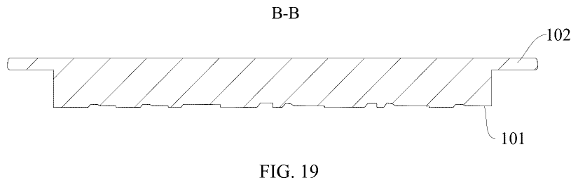

For example, as illustrated in FIGS. 12, and 17 to 19, eight reflecting mirrors 1 form a reflecting mirror group.

In some embodiments, the reflecting mirror 1 includes a fixing part 102 and a reflecting part. The reflecting part and the fixing part 102 have a one-piece structure, and the light-reflecting surface 101 is arranged on the reflecting part.

The vehicle lamp 1000 of embodiments of the present disclosure includes the projection assembly 100 described in any of the above embodiments.

Therefore, the vehicle lamp 1000 of embodiments of the present disclosure has advantages of good road illuminating effect, and so on.

In the related art, the beam pattern produced by the vehicle lamp 1000 on the road surface has a stray light phenomenon, which affects the road illuminating effect of the vehicle lamp 1000.

The vehicle lamp 1000 of embodiments of the present disclosure also includes a light-blocking member 4. The light-blocking member 4 includes a light-blocking part 401, and the light-blocking part 1 is arranged between adjacent two light-entering surfaces 2011, i.e., the light-blocking part 401 is arranged to correspond to the separation part 2013, to separate the adjacent two light-entering surfaces 2011.

The vehicle lamp 1000 of embodiments of the present disclosure, by providing the light-blocking member 4, the light-blocking part 401 of the light-blocking member 4 is utilized to separate the adjacent two light-entering surfaces 2011, which may effectively prevent the light emitted by the light source 3 from shining on the light-entering surface 2011 of the adjacent optical unit and forming the stray light. When the vehicle lamp 1000 with embodiments of the present disclosure is in operation, the stray light may be greatly reduced, or even avoided, which is conducive to improving the road illuminating effect of the vehicle lamp 1000.

Therefore, the vehicle lamp 1000 with embodiments of the present disclosure has advantages of good road illuminating effect, and so on.

In some embodiments, as illustrated in FIGS. 12 to 15, a plurality of light-blocking parts 401 are provided, and the light-blocking part 401 is arranged between any two adjacent light-entering surfaces 2011.

By arranging the light-blocking part 401 between any two adjacent light-entering surfaces 2011, the light emitted by any one light source 3 may be effectively prevented from shining on the light-entering surface 2011 of the adjacent optical unit and forming the stray light, which is conducive to improving the road illuminating effect of the vehicle lamp 1000.

In some embodiments, as illustrated in FIGS. 12 and 15, the light-blocking member 4 also includes a coupling part 402. The plurality of light-blocking parts 401 are coupled to the coupling part 402, and the coupling part 402 is coupled to the lens 2.

When assembling the vehicle lamp 1000, a coupling between the light-blocking member 4 and the lens 2 may be realized by using the coupling part 402 to form a first sub-assembly, and then a coupling between the first sub-assembly and other components may be carried out, so that the light-blocking member 4 may be easily fixed at a preset position of the lens 2.

Therefore, by arranging the coupling part 402 on the light-blocking member 4, the coupling part 402 is coupled to the lens 2, which not only facilitates the assembly of the vehicle lamp 1000, but also effectively improves an assembly accuracy between the light-blocking part 401 and the light-entering surface 2011, facilitating improvement of the road illuminating effect of the vehicle lamp 1000.

In some embodiments, the coupling part 402 and the light-blocking part 401 have a one-piece structure.

In some embodiments, the light-blocking member 4 is a stainless steel member, a plastic member, or an aluminum alloy member.

In some embodiments, the light-blocking part 401 is a light-blocking panel or a light-blocking strip.

In some embodiments, the coupling part 402 is a coupling panel, and the coupling panel has an avoidance part 4021 configured to avoid the light-entering surface 2011. The avoidance part 4021 may be an avoidance hole or an avoidance slot.

In some embodiments, the vehicle lamp 1000 further includes a frame 5, and the coupling part 402 and the lens 2 are both coupled to the frame 5.

For example, as illustrated in FIGS. 12 to 15, the frame 5 is a cover having an accommodating chamber 501, the lens 2 is arranged in the accommodating chamber 501, and the light-blocking member 4 is arranged in the accommodating chamber 501. The lens 2 includes a lens body 201 and a coupling arm 202, and the light-entering surface 2011 and the light-exiting surface 2012 are arranged on the lens body 201.

The frame 5 has a first coupling hole, the coupling arm 202 has a second coupling hole, and the coupling part 402 has a third coupling hole. The vehicle lamp 1000 also includes a first fastener 901, and the first fastener 901 passes through the third coupling hole and the second coupling hole and is coupled to the first coupling hole. A coupling between the light-blocking member 4, the lens 2, and the frame 5 is realized by the first fastener.

In some embodiments, the first fastener 901 may be a bolt, a screw, etc.

In some embodiments, as illustrated in FIG. 12, the vehicle lamp 1000 further includes a PCB panel 6 and a radiator 7. The light source 3 is arranged on the PCB panel 6, and the PCB panel 6 is coupled to the radiator 7 through a second fastener 902. The fixing part 102 is coupled to the radiator 7 through a third fastener 903.

In some embodiments, as illustrated in FIGS. 12, 13, and 15, the frame 5 has a flange 504, and the radiator 7 is coupled to the flange 504 through a fourth fastener 904.

The second fastener 902, the third fastener 903, and the fourth fastener 904 may be bolts, screws, etc.

When assembling the vehicle lamp 1000, the lens 2, the light-blocking member 4, and the frame 5 are assembled into the first sub-assembly; the reflecting mirror 1, the light source 3, the PCB panel 6, and the radiator 7 are assembled into the second sub-assembly; and then, the second sub-assembly is coupled to the first sub-assembly through the fourth fastener 904.

The vehicle of embodiments of the present disclosure includes the vehicle lamp 1000 as described in any of the above embodiments.

Therefore, the vehicle of embodiments of the present disclosure has advantages of good safety, and so on.

The reflecting mirror of embodiments of the present disclosure has a light-reflecting surface. An intersection line of the light-reflecting surface intersecting with a horizontal plane is a first intersection line, and the first intersection line satisfies:

$$\{ \begin{matrix}\frac{tan \frac{- θ x}{l} \cdot {( \frac{d f ( x )}{d x} )}^{2} + 2 \cdot \frac{d f ( x )}{d x} + tan \frac{- θ x}{l}}{{( \frac{d f ( x )}{d x} )}^{2} - 2 tan \frac{- θ x}{l} \cdot \frac{d f ( x )}{d x} + 1} = \frac{x}{f ( x ) - \frac{a}{4}} ; \\ f ( 0 ) = 0\end{matrix}$$

in which,

$$( 0 , \frac{a}{4} )$$

is a focus of the light-reflecting surface, the a is a constant greater than zero; the l is a constant greater than zero; the θ is an angle value greater than 0° and less than 90°; the x is an independent variable, xϵ(−l, l), and the f(x) is a dependent variable changing with the x.

In some embodiments, the θϵ(5°, 10°), and/or the l≤10 mm.

In some embodiments,

$$\{ \begin{matrix}\frac{tan \frac{- γ p}{m} \cdot {( \frac{d f ( p )}{d p} )}^{2} + 2 \cdot \frac{d f ( p )}{d p} + tan \frac{- γ p}{m}}{{( \frac{d f ( p )}{d p} )}^{2} - 2 tan \frac{- γ p}{m} \cdot \frac{d f ( p )}{d p} + 1} = \frac{p}{f ( p ) - \frac{b}{4}} ; \\ f ( 0 ) = 0\end{matrix}$$

in which,

$$( 0 , \frac{b}{4} )$$

is a focus of the light-reflecting surface, the b is a constant greater than zero; the m is a constant greater than zero; the γ is an angle value greater than 0° and less than 90°; the p is an independent variable, pϵ(−m, m), and the f(p) is a dependent variable changing with the p.

In some embodiments, the γϵ(5°, 10°), and/or the m≤10 mm. In some embodiments, the first intersection line extends along a first direction, and a dimension of the light-reflecting surface in the first direction is 5 mm˜15 mm, and/or a focal length of the light-reflecting surface is 0.5 mm˜3 mm.

The projection assembly of embodiments of the present disclosure includes a plurality of optical units. Each optical unit includes a reflecting mirror and a lens, in which the reflecting mirror has a light-reflecting surface, the lens has a light-entering surface, and the light-entering surface is arranged to correspond to the light-reflecting surface. Each optical unit has an optical axis extending in a second direction, the light-reflecting surface and the corresponding light-entering surface are arranged along the second direction, and the reflecting mirror of part of the plurality of optical units is the reflecting mirror described in any of above embodiments.

In some embodiments, part of the plurality of optical units is a first main optical unit, and the first main optical unit satisfies that: a side of the light-reflecting surface distant from the light-entering surface is provided with a first low-beam cut-off line capable of forming a first light and dark cut-off line, the first low-beam cut-off line has a first inflection point capable of forming an elbow of the first light and dark cut-off line, and the first inflection point is arranged on the optical axis.

In some embodiments, a plurality of first main optical unit are provided, the θ of one of the first main optical units is greater than the θ of at least one of the remaining first main optical units.

In some embodiments, part of the plurality of optical units is a second main optical unit, the light-reflecting surface of the reflecting mirror of the second main optical unit is a parabolic surface, and the second main optical unit satisfies that: the side of the light-reflecting surface distant from the light-entering surface is provided with a second low-beam cut-off line capable of forming a second light and dark cut-off line, the second low-beam cut-off line has a second inflection point capable of forming an elbow of the second light and dark cut-off line, and the second inflection point is arranged on the optical axis.

In some embodiments, the lens has a light-exiting surface corresponding to the light-entering surface, the light-entering surface is a light-entering surface collimated in a first direction, the light-exiting surface is a light-exiting surface collimated in a third direction, and the third direction is perpendicular to the first direction.

The vehicle lamp of embodiments of the present disclosure includes the projection assembly as described in any of above embodiments.

The vehicle of embodiments of the present disclosure includes the vehicle lamp as described in any of above embodiments.

In the description of the present disclosure, it should be understood that orientations or position relationships indicated by terms “central”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential”, etc. are based on the orientations or position relationships illustrated in the accompanying drawings, and are only for convenience of describing the present disclosure and simplifying the description, rather than indicating or implying that devices or components referred to must have a particular orientation, be constructed and operated in the particular orientation. Therefore, it cannot be understood as a limitation on the present disclosure.

In addition, terms “first” and “second” are only used to describe the purpose and cannot be understood as indicating or implying relative importance or implying the quantity of technical features indicated. Therefore, features limited to “first” and “second” may explicitly or implicitly include at least one of these features. In the description disclosed herein, “a plurality of” means at least two, such as two, three, etc., unless otherwise specified with specific limitations.

In the present disclosure, unless otherwise specified and limited, terms “mount”, “couple”, “connect”, “fix” and other terms should be broadly understood. For example, they may be a fixed connection, a detachable connection, or integrated. They may also be a mechanical connection, an electrical connection or communication with each other. They may be directly coupled or indirectly coupled through an intermediate medium. They may be an internal connection of two components or an interaction relationship between two components, unless otherwise specified. For ordinary those skilled in the art, specific meanings of the above terms in the present disclosure may be understood based on specific cases.

In the present disclosure, unless otherwise specified and limited, the first feature is “above” or “below” the second feature, which means that the first feature may be in direct contact with the second features, or the first feature may be in indirect contact with the second features through an intermediate media. Moreover, if the first feature is “on”, “above” and “on top of”′ the second feature, which means that the first feature is directly or diagonally above the second feature, or simply indicates that the first feature is horizontally higher than the second feature. The first feature is “under”, “below” and “on bottom of” the second feature, which means that the first feature is directly or diagonally below the second feature, or simply indicates that the horizontal height of the first feature is less than that of the second feature.

In the present disclosure, terms “an embodiment”, “some embodiments”, “an example”, “a specific examples”, or “some examples” means that a specific feature, structure, material, or characteristic described in connection with embodiments or examples is included in at least one embodiment or example of the present disclosure. In this specification, the illustrative expressions of the above terms do not necessarily refer to the same embodiments or examples. Moreover, the specific feature, structure, material, or characteristic described may be combined in any suitable manner in one or more embodiments or examples. In addition, those skilled in the art may connect and combine different embodiments or examples as well as features of different embodiments or examples described in this specification, without conflicting with each other.

Although embodiments of the present disclosure have been illustrated and described above, it may be understood that the above embodiments are illustrative and cannot be understood as a limitation of the present disclosure. Those ordinary skilled in the art may make changes, modifications, alternatives, and variations to the above embodiments within the scope of the present disclosure.

1. A reflecting mirror, comprising a light-reflecting surface, an intersection line of the light-reflecting surface intersecting with a horizontal plane being a first intersection line, and the first intersection line satisfying:
$$\{ \begin{matrix}\frac{tan \frac{- θ x}{l} \cdot {( \frac{d f ( x )}{d x} )}^{2} + 2 \cdot \frac{d f ( x )}{d x} + tan \frac{- θ x}{l}}{{( \frac{d f ( x )}{d x} )}^{2} - 2 tan \frac{- θ x}{l} \cdot \frac{d f ( x )}{d x} + 1} = \frac{x}{f ( x ) - \frac{a}{4}} ; \\ f ( 0 ) = 0\end{matrix}$$
wherein
$$( 0 , \frac{a}{4} )$$
is a focus of the light-reflecting surface, the a is a constant greater than zero; the l is a constant greater than zero; the θ is an angle value greater than 0° and less than 90°; the x is an independent variable, xϵ(−l, l), and the f(x) is a dependent variable changing with the x.

2. The reflecting mirror according to claim 1, wherein the θϵ(5°, 10°).

3. The reflecting mirror according to claim 1, wherein an intersection line of the light-reflecting surface intersecting with a vertical plane is a second intersection line, and the second intersection line satisfies:
$$\{ \begin{matrix}\frac{tan \frac{- γ p}{m} \cdot {( \frac{d f ( p )}{d p} )}^{2} + 2 \cdot \frac{d f ( p )}{d p} + tan \frac{- γ p}{m}}{{( \frac{d f ( p )}{d p} )}^{2} - 2 tan \frac{- γ p}{m} \cdot \frac{d f ( p )}{d p} + 1} = \frac{p}{f ( p ) - \frac{b}{4}} ; \\ f ( 0 ) = 0\end{matrix}$$
wherein
$$( 0 , \frac{b}{4} )$$
is a focus of the light-reflecting surface, the b is a constant greater than zero; the m is a constant greater than zero; the γ is an angle value greater than 0° and less than 90°; the p is an independent variable, pϵ(−m, m), and the f(p) is a dependent variable changing with the p.

4. The reflecting mirror according to claim 3, wherein the γϵ(5°, 10°).

5. The reflecting mirror according to claim 1, wherein the first intersection line extends along a first direction, and a dimension of the light-reflecting surface in the first direction is 5 mm˜15 mm.

6. A projection assembly, comprising:
a plurality of optical units, wherein each optical unit comprises:
a reflecting mirror having a light-reflecting surface; and
a lens having a light-entering surface, the light-entering surface being arranged to correspond to the light-reflecting surface;
wherein each optical unit has an optical axis extending in a second direction, the light-reflecting surface and the corresponding light-entering surface are arranged along the second direction, an intersection line of the light-reflecting surface of the reflecting mirror of part of the plurality of optical units intersecting with a horizontal plane is a first intersection line, and the first intersection line satisfies:
$$\{ \begin{matrix}\frac{tan \frac{- θ x}{l} \cdot {( \frac{d f ( x )}{d x} )}^{2} + 2 \cdot \frac{d f ( x )}{d x} + tan \frac{- θ x}{l}}{{( \frac{d f ( x )}{d x} )}^{2} - 2 tan \frac{- θ x}{l} \cdot \frac{d f ( x )}{d x} + 1} = \frac{x}{f ( x ) - \frac{a}{4}} ; \\ f ( 0 ) = 0\end{matrix}$$
wherein
$$( 0 , \frac{a}{4} )$$
is a focus of the light-reflecting surface, the a is a constant greater than zero; the l is a constant greater than zero; the θ is an angle value greater than 0° and less than 90°; the x is an independent variable, xϵ(−l, l), and the f(x) is a dependent variable changing with the x.

7. The projection assembly according to claim 6, wherein part of the plurality of optical units is a first main optical unit, an intersection line of the light-reflecting surface of the reflecting mirror of the first main optical unit intersecting with the horizontal plane is the first intersection line, and the first main optical unit satisfies that: a side of the light-reflecting surface distant from the light-entering surface is provided with a first low-beam cut-off line capable of forming a first light and dark cut-off line, the first low-beam cut-off line has a first inflection point capable of forming an elbow of the first light and dark cut-off line, and the first inflection point is arranged on the optical axis.

8. The projection assembly according to claim 7, wherein a plurality of first main optical units are provided, and the θ of one of the plurality of first main optical units is greater than the θ of at least one remaining of the plurality of first main optical units.

9. The projection assembly according to claim 7, wherein part of the plurality of optical units is a second main optical unit, the light-reflecting surface of the reflecting mirror of the second main optical unit is a parabolic surface, and the second main optical unit satisfies that: the side of the light-reflecting surface distant from the light-entering surface is provided with a second low-beam cut-off line capable of forming a second light and dark cut-off line, the second low-beam cut-off line has a second inflection point capable of forming an elbow of the second light and dark cut-off line, and the second inflection point is arranged on the optical axis.

10. The projection assembly according to claim 6, wherein the lens has a light-exiting surface corresponding to the light-entering surface, the light-entering surface is a light-entering surface collimated in a first direction, the light-exiting surface is a light-exiting surface collimated in a third direction, and the third direction is perpendicular to the first direction.

11. A vehicle lamp, comprising:
a projection assembly, comprising:
a plurality of optical units;
wherein each optical unit comprises:
a reflecting mirror having a light-reflecting surface; and
a lens having a light-entering surface, the light-entering surface being arranged to correspond to the light-reflecting surface;
wherein each optical unit has an optical axis extending in a second direction, the light-reflecting surface and the corresponding light-entering surface are arranged along the second direction, an intersection line of the light-reflecting surface of the reflecting mirror of part of the plurality of optical units intersecting with a horizontal plane is a first intersection line, and the first intersection line satisfies:
$$\{ \begin{matrix}\frac{tan \frac{- θ x}{l} \cdot {( \frac{d f ( x )}{d x} )}^{2} + 2 \cdot \frac{d f ( x )}{d x} + tan \frac{- θ x}{l}}{{( \frac{d f ( x )}{d x} )}^{2} - 2 tan \frac{- θ x}{l} \cdot \frac{d f ( x )}{d x} + 1} = \frac{x}{f ( x ) - \frac{a}{4}} ; \\ f ( 0 ) = 0\end{matrix}$$
wherein
$$( 0 , \frac{a}{4} )$$
is a focus of the light-reflecting surface, the a is a constant greater than zero; the l is a constant greater than zero; the θ is an angle value greater than 0° and less than 90°; the x is an independent variable, xϵ(−l, l), and the f(x) is a dependent variable changing with the x.

12. A vehicle, comprising the vehicle lamp according to claim 11.

13. The reflecting mirror according to claim 1, wherein the l≤10 mm.

14. The reflecting mirror according to claim 1, wherein the θϵ(5°, 10°) and the l≤10 mm.

15. The reflecting mirror according to claim 3, wherein the m≤10 mm.

16. The reflecting mirror according to claim 3, wherein the ye (5°,) 10° and the m≤10 mm.

17. The reflecting mirror according to claim 1, wherein a focal length of the light-reflecting surface is 0.5 mm˜3 mm.

18. The reflecting mirror according to claim 1, wherein the first intersection line extends along a first direction, and a dimension of the light-reflecting surface in the first direction is 5 mm˜15 mm; and a focal length of the light-reflecting surface is 0.5 mm˜3 mm.

19. The projection assembly according to claim 9, wherein the second low-beam cut-off line and the first low-beam cut-off line have an overlapping part, and the elbow of the first light and dark cut-off line coincides with the elbow of the second light and dark cut-off line.

20. The projection assembly according to claim 6, wherein a plurality of lenses of the plurality of optical units have a one-piece structure, and a separation part is formed between light-entering surfaces of adjacent lenses.
